(19) United States
(12) Patent Application Publication
(10) Pub. No.: US 2019/0173202 A1
(43) Pub. Date: Jun. 6, 2019

(54) Connection Structure and Clamp

(71) Applicant: Yazaki Corporation, Tokyo (JP)

(72) Inventor: Masahito Ozaki, Susono-shi (JP)

(73) Assignee: Yazaki Corporation, Tokyo (JP)

(21) Appl. No.: 16/209,228

(22) Filed: Dec. 4, 2018

(30) Foreign Application Priority Data
Dec. 6, 2017 (JP) 2017-234508

(51) Int. Cl. H01R 4/2408; H01R 4/46; H01R 12/51

(52) U.S. Cl. CPC H01R 4/2408; H01R 12/51; H01R 4/46

(57) ABSTRACT

A connection structure includes an electric wire in which a conductor core wire is coated with an insulating material and a clamp member configured to connect the electric wire to a circuit board. The clamp member includes a first conductor plate mounted on the circuit board to be connected to a circuit and a second conductor plate configured to be attached to the first conductor plate so that at least a part of the second conductor plate comes into contact with the first conductor plate in a state that the electric wire is sandwiched between the first conductor plate and the second conductor plate. At least one of the first conductor plate and the second conductor plate has a protrusion protruding toward the electric wire on a surface of a side facing the electric wire.

### CROSS REFERENCE TO RELATED APPLICATIONS

This application claims priority from Japanese Patent Application No. 2017-234508 filed on Dec. 6, 2017, the entire contents of which are incorporated herein by reference.

### BACKGROUND OF THE INVENTION

### Field of the Invention

The present invention relates to a connection structure which connects an electric wire having a conductor core wire coated with an insulating material to a circuit board.

### Description of Related Art

Usually, various connection structures which connect an electric wire to a circuit board are known (for instance, see patent Literatures 1 and 2). For instance, in one of the usual connection structures, a connector mounted on a circuit board is fitted to a connector attached to a terminal of an electric wire so as to connect the electric wire to the circuit board (see the Patent Literature 1: JP-A-2006-203976).
[Patent Literature 1] JP-A-2006-203976
[Patent Literature 2] JP-B-4242885

According to a related art, in a connection by connectors as in a usual connection structure, since the connectors are attached to both an electric wire and a circuit board, a number of components is the more increased, so that the connection structure is enlarged and complicated in itself.

### SUMMARY

One or more embodiments provide a connection structure of an electric wire and a circuit board in which the electric wire can be connected to the circuit board by a simple structure.

In an aspect (1), one or more embodiments provide a connection structure including an electric wire in which a conductor core wire is coated with an insulating material and a clamp member configured to connect the electric wire to a circuit board. The clamp member includes a first conductor plate mounted on the circuit board to be connected to a circuit and a second conductor plate configured to be attached to the first conductor plate so that at least a part of the second conductor plate comes into contact with the first conductor plate in a state that the electric wire is sandwiched between the first conductor plate and the second conductor plate. At least one of the first conductor plate and the second conductor plate has a protrusion protruding toward the electric wire on a surface of a side facing the electric wire. When the second conductor plate is attached to the first conductor plate, the protrusion is configured to pass through the insulating material to come into contact with the conductor core wire.

In an aspect (2), at least one of the first conductor plate and the second conductor plate has a cut and lift protrusion as the protrusion. The cut and lift protrusion is a part of the at least one of the first conductor plate and the second conductor plate which is punched out toward the electric wire to be a cantilever.

According to the aspect (1), when a first conductor plate is attached to a second conductor plate in a state that an electric wire is held between the first conductor plate mounted on a circuit board and the second conductor plate, a protrusion provided at least in one of the first conductor plate and the second conductor plate passes through an insulating material of the electric wire to come into contact with a conductor core wire. Thus, when the protrusion is provided in, for instance, the first conductor plate, an electrically conductive path is formed which connects together the conductor core wire of the electric wire, the protrusion of the first conductor plate, the first conductor plate and a circuit on the circuit board connected to the first conductor plate in order. Further, when the protrusion is provided in, for instance, the second conductor plate, an electrically conductive path is formed which connects together the conductor core wire of the electric wire, the protrusion of the second conductor plate, a contact position of the second conductor plate and the first conductor plate, the first conductor plate and the circuit on the circuit board connected to the first conductor plate in order. When the protrusions are provided in both of the first conductor plate and the second conductor plate, both the above-described electrically conductive paths are formed. Then, the electric wire is electrically conducted to the circuit along these electrically conductive paths. Accordingly, the electric wire can be electrically connected to the circuit board without requiring the connectors as in the above-described usual connection structure.

Accordingly, the connection structure of the electric wire and the circuit board having the structure of the present invention can connect the electric wire to the circuit board by a structure simpler than the usual connection structure.

According to the aspect (2), a cut and lift protrusion formed in, at least one of the first conductor plate and the second conductor plate is used, so that the insulating material of the electric wire is passed through and the conductor core wire is electrically conducted to the protrusion. Accordingly, an arbitrary number of protrusions can be formed in arbitrary positions by a relatively simple working method that at least one of the first conductor plate and the second conductor plate is partly stamped or blanked out to a cantilever.

According to one or more embodiments, the connection structure of the electric wire and the circuit board can be provided in which the electric wire can be connected to the circuit board by a simple structure.

The present invention is briefly described above. Further, when a mode for carrying out the invention which will be described below is read by referring to the attached drawings, a detail of the present invention will be more clarified.

### BRIEF DESCRIPTION OF THE DRAWINGS

FIG. 1 is a perspective view showing a connection structure of an electric wire and a circuit board according to an exemplary embodiment of the present invention.

FIG. 2A is a cross-sectional view showing a state before a second conductor plate is attached to a first conductor plate. FIG. 2B is a cross-sectional view showing a state that the second conductor plate is attached to the first conductor plate to fix the electric wire between them.

FIG. 3 is a cross-sectional view showing an enlarged periphery of a cut and lift protrusion when a protrusion of the second conductor plate is the cut and lift protrusion.

### DETAILED DESCRIPTION

### Exemplary Embodiment

Now, by referring to the drawings, a connection structure 1 of an electric wire and a circuit board according to an exemplary embodiment of the present invention will be described below.

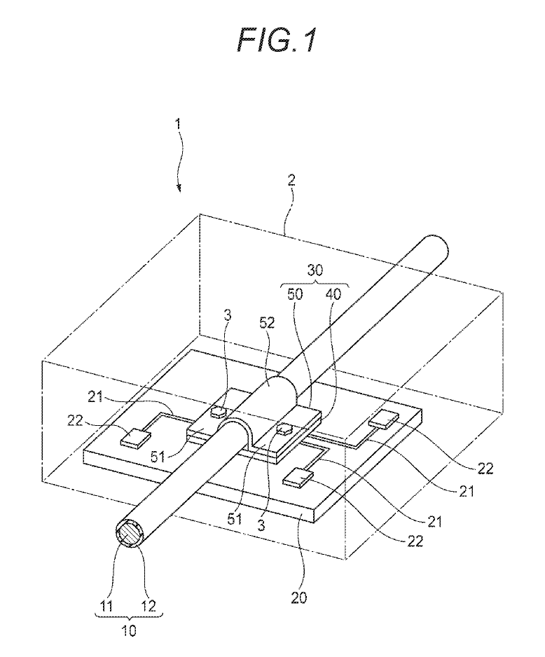

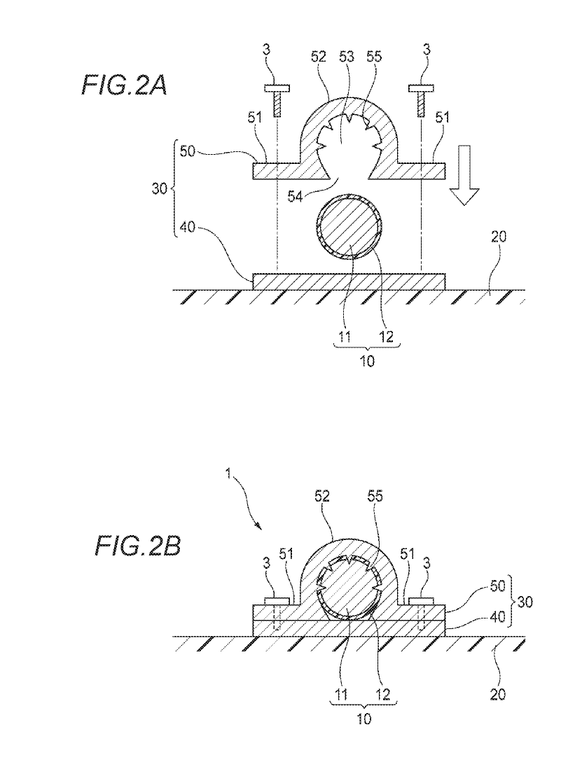

As shown in FIGS. 1 to 2B, the connection structure 1 is a connection structure which connects an electric wire 10 to a circuit board 20 by using a clamp member 30. Now, structures of the electric wire 10, the circuit board 20 and the clamp member 30 will be described below in order.

As shown in FIGS. 1 to 2B, the electric wire 10 includes a conductor core wire 11 having a circular form in section and an insulating coating 12 made of a resin and covering an outer periphery of the conductor core wire 11. In the present exemplary embodiment, the conductor core wire 11 is formed with one rod shaped conductor. The conductor core wire 11 is formed with electrically conductive metal and may be preferably formed with aluminum or aluminum alloy, or copper or copper alloy for the purpose of light weight and low cost.

As shown in FIG. 1, the circuit board 20 is a rectangular flat plate shaped board fixed and arranged in an inner part of a parallelepiped casing 2 in this example. The circuit board 20 is formed with an insulating material such as a resin. On a surface (an upper surface) of the circuit board 20, a plurality of circuits (electrically conductive paths) 21 having prescribed patterns are printed and formed and a plurality of electronic parts 22 are mounted. To the electronic parts 22 respectively, one ends of corresponding circuits 21 are respectively electrically connected.

As shown in FIGS. 1 to 2B, the clamp member 30 includes a first conductor plate 40 and a second conductor plate 50. The first conductor plate 40 is a rectangular flat plate shaped metal plate in this exemplary embodiment. The first conductor plate 40 is fixed to the surface (the upper surface) of the circuit board 20 in such a way that the other ends of the plurality of circuits 21 are respectively electrically connected to the first conductor plate 40. Accordingly, the electronic parts 22 are respectively electrically connected to the first conductor plate 40 through the corresponding circuits 21.

The second conductor plate 50 is a metal plate formed with a pair of flat plate parts 51 and an electric wire accommodation part 52 which connects the pair of flat plate parts 51, and has the same rectangular outline form as that of the first conductor plate 40 in plan view. The flat plate parts 51 respectively have a long strip form extending in a direction of depth (refer it to as a “first direction”, hereinafter) in FIGS. 1 to 2B. One pair of flat plate parts 51 are located so as to be arranged with prescribed space left in a direction of width (refer it to as a “second direction”, hereinafter) intersecting at right angles to the first direction. Lower surfaces of the one pair of flat plate parts 51 are respectively located in the same plane.

The electric wire accommodation part 52 protrudes upward to the one pair of flat plate parts 51 and has a partly cylindrical form extending over an entire area of the first direction. The partly cylindrical form indicates a three-dimensional form obtained by removing a part of a circumferential direction of a cylinder over an entire area in an axial direction. In an inner part of the electric wire accommodation part 52, an electric wire accommodation space 53 (see FIG. 2A) is formed which extends in the first direction to accommodate the electric wire 10. A radius of curvature of an inner wall of the electric wire accommodation part 52 is designed so as to have a dimension corresponding to an outside diameter of the electric wire 10. The electric wire accommodation space 53 communicates with an external part through a rectangular opening 54 defined between the one pair of flat plate parts 51.

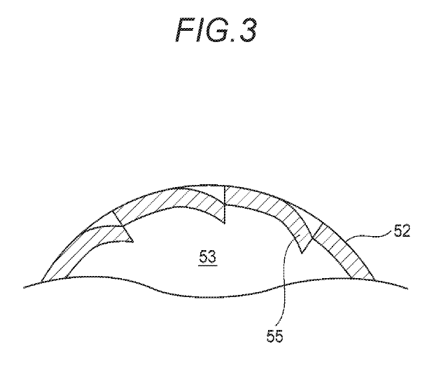

In the inner wall of the electric wire accommodation part 52, a plurality of protrusions 55 are provided which protrude inward in a radial direction at a plurality of positions in the circumferential direction and the first direction. As the protrusion 55, as shown in FIG. 3, a cut and lift protrusion is preferably and suitably used which is formed in such a way that a part of the electric wire accommodation part 52 is punched out inward in the radial direction (namely, the electric wire 10) in a cantilever. Thus, the second conductor plate 50 can be manufactured only by applying a press working or a blanking or stamping work to a metal flat plate. The structures of the electric wire 10, the circuit board 20 and the clamp member 30 are described above.

Subsequently, an attachment of the electric wire 10, the circuit board 20 and the clamp member 30 will be described below. In order to connect the electric wire 10 to the circuit board 20 by using the clamp member 30, initially, the electric wire 10 is accommodated in the electric wire accommodation space 53 through the opening 54 of the second conductor plate 50. Under this state, the plurality protrusions 55 ordinarily merely come into contact with the insulating coating 12 of the electric wire 10 and do not pass through the insulating coating 12. Accordingly, under this state, since a space for a protruding height of the protrusion 55 exists between the electric wire 10 and the inner wall of the electric wire accommodation part 52, a lowermost part of the electric wire 10 protrudes downward from the lower surfaces of the one pair of flat plate parts 51. After that, the second conductor plate 50 in which the electric wire 10 is accommodated is mounted on an upper surface of the first conductor plate 40 fixed to the upper surface of the circuit board 20 and one pair of bolts 3 are used to fix the second conductor plate 50 on the first conductor plate 40 in such a way that the one pair of flat plate parts 51 come into tight contact with the upper surface of the first conductor plate 40.

At this time, the lowermost part of the electric wire 10 protruding downward from the lower surfaces of the one pair of flat plate parts 51 is pressed upward by the upper surface of the first conductor plate 40. Thus, the electric wire 10 receives a force in a direction that the electric wire 10 comes near to the inner wall of the electric wire accommodation part 52. As a result, the electric wire 10 moves relatively upward in the electric wire accommodation space 53. Thus, as shown in FIG. 2B, the plurality of protrusions 55 pass through the insulating coating 12 of the electric wire 10 and come into contact with the conductor core wire 11 of the electric wire 10 and an outer peripheral surface of the electric wire 10 comes into tight contact with the inner wall of the electric wire accommodation part 52. Accordingly, a connection of the electric wire 10 and the circuit board 20 is completed to obtain the connection structure 1. At this time, the above-described attachment is carried out by applying an external force so as to pull the electric wire 10 in an axial direction. Thus, the insulating coating 12 is torn off from positions where the protrusions 55 stick as starting points, so that an exposed area of the conductor core wire 11 is increased to more assuredly electrically conduct the conductor core wire 11 to the second conductor plate 50.

In the connection structure 1 of the electric wire and the circuit board according to the exemplary embodiment of the present invention, since the second conductor plate 50 is attached to the first conductor plate 40 mounted on the circuit board 20, the electric wire 10 can be fixedbetween them. Further, the plurality of protrusions 55 provided in the second conductor plate 50 pass through the insulating coating 12 of the electric wire 10 sandwiched between the first conductor plate 40 and the second conductor plate 50 and come into contact with the conductor core wire 11 of the electric wire 10. Thus, an electrically conductive path is formed which connects together the conductor core wire 11 of the electric wire 10, the protrusions 55 of the second conductor plate 50, a contact part of the first conductor plate 40 and the second conductor plate 50, the first conductor plate 40, the circuits 21 on the circuit board 20 and the electronic parts 22 in order. Accordingly, the electric wire 10 can be electrically connected to the circuit board 20 without requiring the connectors as the above-described usual connection structure.

Accordingly, the connection structure 1 of the electric wire and the circuit board having the structure of the present invention can connect the electric wire 10 to the circuit board 20 by a simple structure.

### Other Exemplary Embodiments

The present invention is not limited to the above-described exemplary embodiment and various modified examples may be adopted within a range of the present invention. For instance, the present invention is not limited to the above-described exemplary embodiment and may be suitably modified and improved. In addition thereto, materials, forms, dimensions, numbers, arranged positions or the like of various components in the above-described exemplary embodiment may be arbitrary as long as the present invention can be achieved.

For instance, in the above-described exemplary embodiment, the conductor core wire is formed with the one rod shaped conductor. However, a plurality of conductors may be bundled to form the conductor core wire. A sectional form of the conductor core wire 11 (the electric wire 10) may not be circular, but may be rectangular. When the sectional form of the electric wire 10 is rectangular, the electric wire accommodation part 52 of the second conductor plate 50 has a form of a rectangular tube including a pair of side walls and an upper wall and opened downward. A plurality of protrusions 55 are preferably provided so as to protrude downward only from an inner wall of the upper wall.

Further, in the above-described exemplary embodiment, as the protrusions 55, the cut and lift protrusions are used which are formed in such a way that the electric wire accommodation part 52 of the second conductor plate 50 is partly punched out inward in the radial direction to have the shapes of cantilevers (see FIG. 3). However, a metallic protruding single body may be connected to the inner wall of the electric wire accommodation part 52 of the second conductor plate 50 by welding to form a protrusion 55.

Further, in the above-described exemplary embodiment, the protrusions 55 are provided in the second conductor plate 50. However, the protrusions may be provided in the first conductor plate 40 and also may be provided in both of the first conductor plate 40 and the second conductor plate 50.

Here, features of the above-described connection structure 1 of the electric wire and the circuit board according to the present invention will be briefly summarized and described in below-described (1) to (8).

(1) A connection structure (1) comprising:
an electric wire (10) in which a conductor core wire (11) is coated with an insulating material (12); and
a clamp member (30) configured to connect the electric wire (10) to a circuit board (20),
wherein the clamp member (30) includes a first conductor plate (40) mounted on the circuit board (20) to be connected to a circuit (21) and a second conductor plate (50) configured to be attached to the first conductor plate (40) so that at least a part of the second conductor plate (50) comes into contact with the first conductor plate (40) in a state that the electric wire (10) is sandwiched between the first conductor plate (40) and the second conductor plate (50),
wherein at least one of the first conductor plate (40) and the second conductor plate (50) has a protrusion (55) protruding toward the electric wire (10) on a surface of a side facing the electric wire (10), and
wherein when the second conductor plate (50) is attached to the first conductor plate (40), the protrusion (55) is configured to pass through the insulating material (12) to come into contact with the conductor core wire (11).
   (2) The connection structure (1) according to the above-described (1)
wherein at least one of the first conductor plate (40) and the second conductor plate (50) has a cut and lift protrusion as the protrusion (55), and
wherein the cut and lift protrusion is a part of the at least one of the first conductor plate (40) and the second conductor plate (50) which is punched out toward the electric wire (10) to be a cantilever.
   (3) The connection structure (1) according to the above-described (1)
wherein the second conductor plate (50) includes a pair of flat plate parts (51) and an electric wire accommodation part (52) which connects the pair of flat plate parts (51) to each other.
   (4) The connection structure (1) according to the above-described (1)
wherein the electric wire accommodation part (52) protrudes against the one pair of flat plate parts (51) and has a partly cylindrical form extending over an entire area of one direction in a same plane as the second conductor plate (50).
   (5) A clamp member (30) comprising:
a first conductor plate (40) mounted on a circuit board (20) to be connected to a circuit (21); and
a second conductor plate (50) configured to be attached to the first conductor plate (40) so that at least a part of the second conductor plate (50) comes into contact with the first conductor plate (40) in a state that an electric wire (10) in which a conductor core wire (11) is coated with an insulating material (12) is sandwiched between the first conductor plate (40) and the second conductor plate (50),
wherein at least one of the first conductor plate (40) and the second conductor plate (50) has a protrusion (55) protruding toward the electric wire (10) on a surface of a side facing the electric wire (10), and
wherein when the second conductor plate 50 is attached to the first conductor plate (40), the protrusion (55) is configured to pass through the insulating material (12) to come into contact with the conductor core wire (11).
   (6) The clamp member (30) according to the above-described (5)
wherein at least one of the first conductor plate (40) and the second conductor plate (50) has a cut and lift protrusion as the protrusion (55), and
wherein the cut and lift protrusion is a part of the at least one of the first conductor plate (40) and the second conductor plate (50) which is punched out toward the electric wire (10) to be a cantilever.
   (7) The clamp member (30) according to the above-described (5)
wherein the second conductor plate (50) includes a pair of flat plate parts (51) and an electric wire accommodation part (52) which connects the pair of flat plate parts (51) to each other.
   (8) The clamp member (30) according to the above-described (7)
wherein the electric wire accommodation part (52) protrudes against the one pair of flat plate parts (51) and has a partly cylindrical form extending over an entire area of one direction in a same plane as the second conductor plate (50).

### DESCRIPTION OF REFERENCE NUMERALS AND SIGNS

1 . . . connection structure of electric wire and circuit boar
10 . . . electric wire
11 . . . conductor core wire
12 . . . insulating coating (insulating material)
20 . . . circuit board
21 . . . circuit
30 . . . clamp member
40 . . . first conductor plate
50 . . . second conductor plate
55 . . . protrusion

What is claimed is:

1. A connection structure comprising:
an electric wire in which a conductor core wire is coated with an insulating material; and
a clamp member configured to connect the electric wire to a circuit board,
wherein the clamp member includes a first conductor plate mounted on the circuit board to be connected to a circuit and a second conductor plate configured to be attached to the first conductor plate so that at least a part of the second conductor plate comes into contact with the first conductor plate in a state that the electric wire is sandwiched between the first conductor plate and the second conductor plate,
wherein at least one of the first conductor plate and the second conductor plate has a protrusion protruding toward the electric wire on a surface of a side facing the electric wire, and
wherein when the second conductor plate is attached to the first conductor plate, the protrusion is configured to pass through the insulating material to come into contact with the conductor core wire.

2. The connection structure according to claim 1,
wherein at least one of the first conductor plate and the second conductor plate has a cut and lift protrusion as the protrusion, and
wherein the cut and lift protrusion is a part of the at least one of the first conductor plate and the second conductor plate which is punched out toward the electric wire to be a cantilever.

3. The connection structure according to claim 1,
wherein the second conductor plate includes a pair of flat plate parts and an electric wire accommodation part which connects the pair of flat plate parts to each other.

4. The connection structure according to claim 1,
wherein the electric wire accommodation part protrudes against the one pair of flat plate parts and has a partly cylindrical form extending over an entire area of one direction in a same plane as the second conductor plate.

5. A clamp member comprising:
a first conductor plate mounted on a circuit board to be connected to a circuit; and
a second conductor plate configured to be attached to the first conductor plate so that at least a part of the second conductor plate comes into contact with the first conductor plate in a state that an electric wire in which a conductor core wire is coated with an insulating material is sandwiched between the first conductor plate and the second conductor plate,
wherein at least one of the first conductor plate and the second conductor plate has a protrusion protruding toward the electric wire on a surface of a side facing the electric wire, and
wherein when the second conductor plate is attached to the first conductor plate, the protrusion is configured to pass through the insulating material to come into contact with the conductor core wire.

6. The clamp member according to claim 5,
wherein at least one of the first conductor plate and the second conductor plate has a cut and lift protrusion as the protrusion, and
wherein the cut and lift protrusion is a part of the at least one of the first conductor plate and the second conductor plate which is punched out toward the electric wire to be a cantilever.

7. The clamp member according to claim 5,
wherein the second conductor plate includes a pair of flat plate parts and an electric wire accommodation part which connects the pair of flat plate parts to each other.

8. The clamp member according to claim 7,
wherein the electric wire accommodation part protrudes against the one pair of flat plate parts and has a partly cylindrical form extending over an entire area of one direction in a same plane as the second conductor plate.
